(19) United States
(12) Patent Application Publication
(10) Pub. No.: US 2006/0134475 A1
(43) Pub. Date: Jun. 22, 2006

(54) Air humidifying system for fuel cell stack

(76) Inventors: Liqing Hu, Shanghai (CN); Jianwei Xia, Shanghai (CN); Bo Zhang, Shanghai (CN)

Correspondence Address: Raymond Y. Chan;Suite 128, 108 N. Ynez Ave., Monterey Park, CA, 91754, US

(21) Appl. No.: 11/016,279

(22) Filed: Dec. 17, 2004

(51) Int. Cl. H01M 8/18

(52) U.S. Cl. 429/19

(57) ABSTRACT

An air humidifying system includes an air humidifying device including a humidifying unit, having a dry air inlet and a humidified air outlet, for humidifying a flow of dry air from the dry air inlet to a humidified air exiting at the humidified air outlet. An air filtering unit has an air filtering inlet for guiding an ambient air as the dry air and an air filtering outlet communicating with the dry air inlet of the humidifying unit for purifying the dry air before entering into the humidifying unit. An air supplying unit has an air inlet port communicating with the humidified air outlet of the humidifying unit and an air outlet port adapted for communicating with an air inlet of the fuel cell stack, wherein the air supplying unit is adapted for guiding the humidified air into the fuel cell stack in a pressurized manner.

### BACKGROUND OF THE PRESENT INVENTION

1. Field of Invention

The present invention relates to fuel cell, more particularly, relates to an efficient air humidifying system for a fuel cell stack.

2. Description of Related Arts

Electrochemical fuel cell is a kind of electrochemical energy conversion device which is capable of converting the hydrogen and oxidant into electrical energy. The core part of this kind of device is a MEA (Membrane Electrode Assembly). The MEA includes a proton exchange membrane sandwiched by two porous sheets made of conductive material such as carbon tissue. At the same time, a layer of catalyst like metal platinum powder, adapted for facilitating the electrochemical reaction, are evenly and granularly provided on two layers of carbon tissue to form two catalytic interfaces. Furthermore, electrically conductible flow field plates are provided on two sides of the MEA to form a cathode and an anode, in such a manner, electron generated from the electrochemical reaction are capable of being lead out through an electrical circuit.

The anode of the MEA is supplied with fuel, such as hydrogen, for initiating the electrochemical reaction. On the other hand, an oxidant-containing gas, such as air, is supplied to the cathode of the MEA. Accordingly, the fuel supplied to the anode is adapted to be deionized for the loss of electrons to generate positive ions (protons), and the oxidant-containing gas on the cathode is adapted to be ionized for the addition of the electrons to generate negative ions. Finally, the positive ions transferred from the anode will meet the negative ions to form reaction product.

Here, the proton exchange membrane is capable of facilitating the positive ions migrate from the anode to the cathode. Moreover, the proton exchange membrane has another function as a separator for blocking fuel flow from being directly contacted with the oxygen containing air flow so as to prevent the mixture of hydrogen and oxygen as well as the explosive reaction.

The electrochemical reaction of the common electrochemical fuel cells is expressed by the following formula:
Anode: H₂→2H⁺+2e
Cathode: 1/2O₂+2H⁺+2e→HO

In the typical proton exchanging membrane fuel cell system, the MEA is disposed between two electrically conductible electrode plates, namely an anode flow field plate and a cathode flow field plate, wherein the contacting interface of each electrode flow field plate at least defines one flowing groove thereon. The electrode flow field plate could be embodied as metal electrode plate or graphite electrode plate. So the flowing grooves defined on the electrode flow field plate are capable of directing fuel and oxidant into anode reacting interface and cathode reacting interface respectively positioned on opposite side of the MEA.

To increase the overall power output of the proton exchanging membrane fuel cell, two or more fuel cells are electrically connected in series with a stacked manner or a successive manner to form a fuel cell stack. In such a stacked manner, each electrode flow field plate comprises flowing grooves defined on opposite side of plate body respectively wherein one side of the electrode flow field plate is applied as an anode flow field plate contacting with the anode interface of a MEA, while another side of the electrode flow field plate is functioned as a cathode flow field plate contacting with the cathode interface of an adjacent MEA.

Commonly, a plurality of individual fuel cell units are connected in series to form above mentioned fuel cell stack, wherein a pair of end plates, namely a front end plate and a rear end plate are disposed at two ends of the fuel cell stack, and at least one attaching means adapted for holding two end plates is provided for securely sandwiching the fuel cell stack between two end plates.

Furthermore, to ensure the fluids reach all fuel cell units, the fuel cell stack further comprises a plurality of manifolds extending longitudinally for delivering the reactant fluids within the fuel cell stack, namely, a fuel manifold for directing fuel, such as hydrogen, methanol, alcohol, natural gas, and hydrogen rich gas reformed from gasoline into the anode flowing channels of each of fuel cell unit, an oxidant manifold for directing oxidant, such as oxygen and air, into the cathode flowing channel of each of fuel cell unit, and a coolant manifold extended across the fuel cell stack for delivering coolant like water into each fuel cell unit to absorb the heat generated from the electrochemical reaction inside the fuel cell stack. Conventionally, the inlets and outlets of such manifolds are defined on the front end plate and the rear end plate.

It has been practiced in the art to use such fuel cell stack as power system for propelling vehicles and ships, and operating other electrically operated machines such as portable generators and fixed generators.

The essential part of a proton exchange membrane fuel cell is the MEA, while the proton exchange membrane is the core part of the MEA. To maintain high electrical generation efficiency, the proton exchange membrane must be maintained in a water-saturated state so as to enable the electrochemical process running smoothly.

This is due to the fact that hydrated protons are capable of freely penetrating the proton exchange membrane, i.e. migrating from the anode side to the cathode side to generate an electrochemical reaction. Otherwise, if the fuel cell was supplied with dried air, water molecules existed in the proton exchange membrane will be blow away thus causing protons being encumbered penetrating the proton exchange membrane. This would result the impedance of the electrodes rapidly increased, and finally deteriorate the fuel cell performance. As a result, the air supplied to the fuel cell commonly will be humidified first to prevent the proton exchange membrane being dehydrated.

Within the prior art, there are two kind of humidifying devices widely used for incorporating with proton exchange membrane fuel cell. The first kind of humidifying device pumps purified water into humidifying devices wherein water molecules are evaporated to be mixed with air molecules so as to generate evenly mixed gaseous air. Therefore, the air supplied to the fuel cell will have certain extent of humidity. The second kind of humidifying device utilizes dampening exhausted air and water discharged from the electrochemical reaction of fuel cell to humidify proton exchange membrane.

Thus, the first kind of device requires the purified water pumped in from an outside resource. However, pumping purified water needs extra equipments such as water pump, water pipes to facilitate the humidifying process, thus making the humidifying device further complex and increasing energy consumption. Moreover, since the purified water is consumed from time to time, it is unaffordable to run such a humidifying operation.

Comparably, the second kind of humidifying device is more practical and economical. Ordinarily, this kind of humidifying device utilizes a spirally configured humidifying cylinder to moisturize the air supplied to the fuel cell stack, as disclosed in a China patent number 02111824.8. Recently, a kind of water permeable and air unbreathable membrane, like Nafion membrane of Dupont has been widely used in the market. As its name implies, such kind of membrane will allow water molecules being freely permeable while blocking air molecules, so as to provide an unparalleled power output and a reliable durability. Accordingly, the dry air is supplied to one side of the Nafion membrane, the humidified exhausted air and water discharged from the electrochemical reaction is flowing on the other side of the membrane, wherein water molecules are capable of penetrating the membrane to diffuse into the dry air so as to humidify the dry air. U.S. Pat. No. 6,106,964, titled as “Solid polymer fuel cell system and method for humidifying and adjusting the temperature of a reactant stream”, is just employing this kind of humidifying mechanism.

Conclusively, almost all humidifying devices within the art are basically utilizing the same designing concept illustrated in U.S. Pat. No. 6,106,964. The humidifier is disposed between the air supplying means, such as air compressor and high pressure fan, and the fuel cell stack.

As shown in FIG. 1, the dry air is sucked in by the air supplying means A1 first, and then is compressed by the air compressor to flow through the humidifying device A2 before entering into the fuel cell stack A3 to generate an electrochemical reaction, and finally, exhausted air and water discharged from the fuel cell stack A3 are directed for reentering the humidifying device A2 to exchange heat and water with dry air.

However, the humidifying device also suffers some drawbacks. First of all, the air supplying means Al, such as an electrical fan would only provide a relatively lower air pressure, which is too low to overcome a liquid resistance of the humidifying device A2. As a result, the air supplied to the fuel cell stack A3 would suffer considerable pressure loss as well as flow loss, thereby resulting in an inferior performance of the whole fuel cell stack A3. Secondly, under such assembly concept, the pressure of dry air supplied to the humidifying device A2 would be higher than the pressure of air discharged from the humidifying device A2. This pressure difference would cause an internal leakage of the humidifying device A2, and the leak would result to the pressure running off, i.e. air of higher pressure supplied to the fuel cell stack A3 would be escape from the leakage of the humidifying device A2, so as to damage the performance of the fuel cell stack A3. Meanwhile, the exhausted water molecules are flow along the lower pressure side of the humidifying membrane, the pressure difference create a natural barrier for preventing the moisturized water molecules being diffused into the higher pressure side wherein the dry air is provided.

### SUMMARY OF THE PRESENT INVENTION

A main object of the present invention is to provide an air humidifying system for a fuel cell stack wherein the humidifying system is efficient and pressure-loss preventative so as to overcome above mentioned drawbacks thereby facilitating the overall performance of the fuel cell stack.

Another object of the present invention is to provide an air humidifying system for a fuel cell stack wherein the humidifying system is disposed between an air filter and air supplying means, such as an electrical fan, so that the air pressure flowing along two side of humidifying system are well balanced for preventing air pressure and flow loss during the operation.

Another object of the present invention is to provide an air humidifying system for a fuel cell stack, wherein the air provided to the air supplying means, such as an electrical fan, are humidified for facilitating the ions exchanging process within the fuel cell stack.

Accordingly, to achieve the above mention object, the present invention provides an air humidifying system for a fuel cell stack, comprising:

an air humidifying device comprising a humidifying unit, having a dry air inlet and a humidified air outlet, for humidifying a flow of dry air from the dry air inlet to a humidified air exiting at the humidified air outlet;

an air filtering unit having an air filtering inlet for guiding an ambient air as the dry air and an air filtering outlet communicating with the dry air inlet of the humidifying unit for purifying the dry air before entering into the humidifying unit; and

an air supplying unit having an air inlet port communicating with the humidified air outlet of the humidifying unit and an air outlet port adapted for communicating with an air inlet of the fuel cell stack, wherein the air supplying unit is adapted for guiding the humidified air into the fuel cell stack in a pressurized manner.

These and other objectives, features, and advantages of the present invention will become apparent from the following detailed description, the accompanying drawings, and the appended claims.

### BRIEF DESCRIPTION OF THE DRAWINGS

FIG. 1 illustrates a conventional air humidifying system for a fuel cell stack.

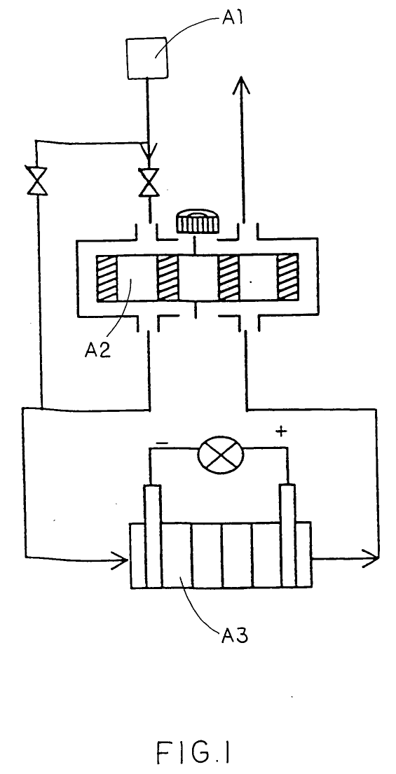

FIG. 2 is a schematic view of an air humidifying system for a fuel cell stack according to the preferred embodiment of the present invention.

FIG. 3 is a block diagram of the air humidifying system for the fuel cell stack according to the above preferred embodiment of the present invention.

### DETAILED DESCRIPTION OF THE PREFERRED EMBODIMENT

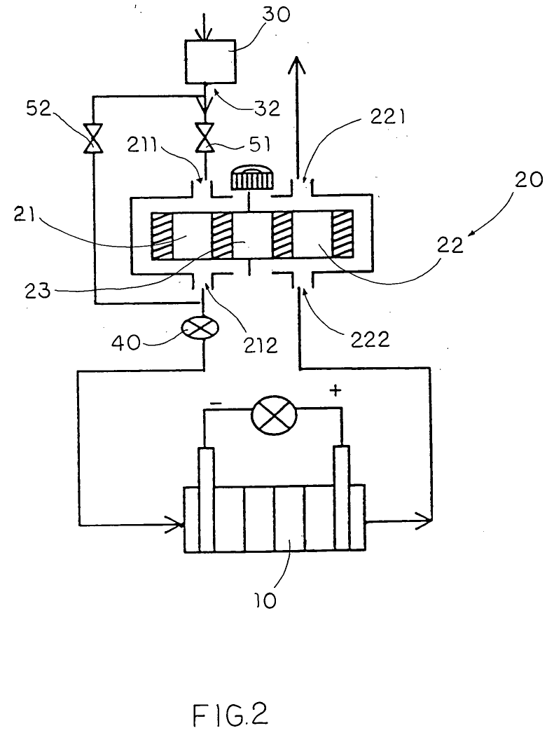

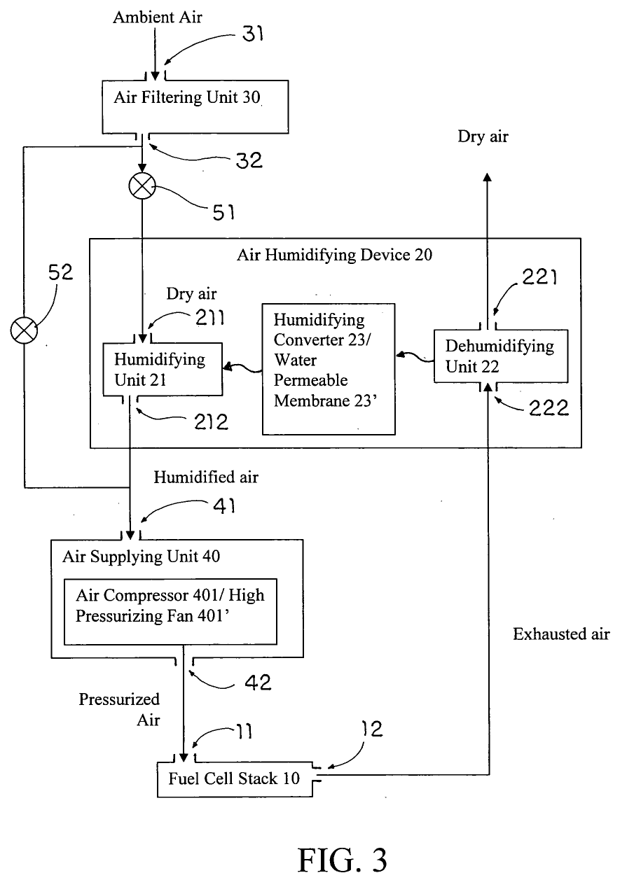

Referring to the FIGS. 2 and 3 of the drawings, an air humidifying system for a fuel cell stack 10 according to the preferred embodiment of the present invention is illustrated. The air humidifying system comprises an air humidifying device 20, an air filtering unit 30, and air supplying unit 40.

The air humidifying device 20 comprises a humidifying unit 21 having a dry air inlet 211 and a humidified air outlet 212, wherein the humidifying unit 21 is adapted for humidifying a flow of dry air from the dry air inlet 211 to a humidified air exiting at the humidified air outlet 212

The air filtering unit 30 has an air filtering inlet 31 for guiding an ambient air as the dry air and an air filtering outlet 32 communicating with the dry air inlet 211 of the humidifying unit 21 for purifying the dry air before entering into the humidifying unit 21. Accordingly, the air filtering unit 30 is adapted to filter the particles in the ambient air so as to prevent any air pollution of the fuel cell stack 10.

The air supplying unit 40 has an air inlet port 41 communicating with the humidified air outlet 212 of the humidifying unit 21 and an air outlet port 42 adapted for communicating with an air inlet 11 of the fuel cell stack 10, wherein the air supplying unit 40 is adapted for guiding the humidified air into the fuel cell stack 10 in a pressurized manner.

According to the preferred embodiment of the present invention, the humidifying unit 21 is positioned between the air filtering unit 30 and the air supplying unit 40, wherein the filtered ambient air as the dry air is guided into the humidifying unit 21 to moisturize and heat up the dry air to become the humidified air before entering into the air supplying unit 40 so as to prevent the loss of the flow velocity of humidified air entering into the fuel cell stack 10. In other words, the dry air is firstly moisturized and then pressurized before entering into the fuel cell stack 10.

The air supplying unit 40 is arranged to pressurize the humidified air from the humidifying unit 21 to the fuel cell stack 10, wherein the air supplying unit 40 generates an air pressure difference between the air inlet port 41 and the air outlet port 42 such that the humidified air is force to flow into the fuel cell stack 10 in a high pressure manner. In other words, since the air supplying unit 40 is positioned between the humidifying unit 21 and the fuel cell stack 10, the air supplying unit 40 not only minimizes the internal leakage of the humidifying unit 21 under a relative high pressure but also ensures the flow of the humidified air entering into the fuel cell stack 10.

Accordingly, the air supplying unit 40 comprises an air compressor 401 operatively connecting between the humidified air outlet 212 of the humidifying unit 21 and the air inlet 11 of the fuel cell stack 10 for pressurizing the humidified air into the fuel cell stack 10. The air supplying velocity is 3 to 5 square meter/per minute and the air pressure is 0.6 Bar.

Alternatively, the air supplying unit 40 comprises a high pressurizing fan 401′ operatively connecting between the humidified air outlet 212 of the humidifying unit 21 and the air inlet 11 of the fuel cell stack 10 for pressurizing the humidified air into the fuel cell stack 10. It is worth to mention that the high pressurizing fan 401′ is made of utility plastic materials or made of surface-treated aluminum material.

According to the preferred embodiment, the air humidifying device 20 further comprises a dehumidifying unit 22 having a dehumidified air outlet 221 and a dehumidified air inlet 222 adapted for communicating with an air outlet 12 of the fuel cell stack 10, wherein the dehumidifying unit 22 is adapted for dehumidifying an exhausted air from the fuel cell stack 10 to an atmosphere at the dehumidified air outlet 221. In other words, the exhaust air is dehumidified to become the dry air as the ambient air and can be recycled to flow back to the air filtering unit 30.

As shown in FIG. 3, the air humidifying device 20 further comprises a humidifying converter 23 which is mounted between the humidifying unit 21 and the dehumidifying unit 22 and is arranged when the humidifying converter 23 is driven to rotate, moisture of the exhausted air is removed at the dehumidifying unit 22 and transferred to the humidifying unit 21 for humidifying the dry air. In other words, the moisture of the exhausted air is dehumidified for humidifying the dry air.

Alternatively, the humidifying converter 23 can be substituted as a water permeable membrane 23′, such as Nafion membrane, which is positioned between the humidifying unit 21 and the dehumidifying unit 22 and is arranged in such a manner that when the exhausted air of the fuel cell stack 10 passes through the water permeable membrane 23′, moisture of the exhausted air is removed by the water permeable membrane 23′ and transferred to the humidifying unit 21 for humidifying the dry air.

It is worth to mention that since the humidified air is pressured by the air supplying unit 40 into the fuel cell stack 10, the exhaust air from the fuel cell stack 10, which has a predetermined pressure, flows to the dehumidifying unit 22. Therefore, an air pressure at the humidifying unit 21 is lower than an air pressure at the dehumidifying unit 22 to enhance a diffusion of the exhaust air from the dehumidifying unit 22 to the humidifying unit 21 through the humidifying converter 23 or the water permeable membrane 23′.

The air humidifying system further comprises a first air valve 51 communicatively connecting between the dry air inlet 211 of the humidifying unit 21 and the air filtering outlet 32 of the air filtering unit 30 and a second air valve 52 communicatively connecting between the humidified air outlet 212 of the humidifying unit 21 and the air filtering outlet 32 of the air filtering unit 30, wherein the first and second air valves 51, 52 automatically control the dry air flow entering into the humidifying unit 21 for controlling a relative humidity of the humidified air supplied to the fuel cell stack 10 which adjusts the electrochemical reaction of the fuel cell stack 10. Preferably, the first valve 51 and the second valve 52 are embodied as electrical auto-application valves. By purposely operating the first valve 51 and second valve 52, the user is able to control the air flow through the humidifying unit 21, so as to control the relative humidity of the air supplied to the fuel cell stack 10.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An air humidifying system for a fuel cell stack, comprising:
an air humidifying device comprising a humidifying unit, having a dry air inlet and a humidified air outlet, for humidifying a flow of dry air from said dry air inlet to a humidified air exiting at said humidified air outlet;
an air filtering unit having an air filtering inlet for guiding an ambient air as said dry air and an air filtering outlet communicating with said dry air inlet of said humidifying unit for purifying said dry air before entering into said humidifying unit; and
an air supplying unit having an air inlet port communicating with said humidified air outlet of said humidifying unit and an air outlet port adapted for communicating with an air inlet of said fuel cell stack, wherein said air supplying unit is adapted for guiding said humidified air into said fuel cell stack in a pressurized manner.

2. The air humidifying system, as recited in claim 1, wherein said air humidifying device further comprises a dehumidifying unit having a dehumidified air outlet and a dehumidified air inlet adapted for communicating with an air outlet of said fuel cell stack, wherein said dehumidifying unit is adapted for dehumidifying an exhausted air from said fuel cell stack to an atmosphere at said dehumidified air outlet.

3. The air humidifying system, as recited in claim 2, wherein said air humidifying device further comprises a humidifying converter which is mounted between said humidifying unit and said dehumidifying unit and is arranged when said humidifying converter is driven to rotate, moisture of said exhausted air is removed at said dehumidifying unit and transferred to said humidifying unit for humidifying said dry air.

4. The air humidifying system, as recited in claim 2, wherein said air humidifying device further comprises a water permeable membrane which is positioned between said humidifying unit and said dehumidifying unit and is arranged in such a manner that when said exhausted air of said fuel cell stack passes through said water permeable membrane, moisture of said exhausted air is removed by said water permeable membrane and transferred to said humidifying unit for humidifying said dry air.

5. The air humidifying system, as recited in claim 3, wherein an air pressure at said humidifying unit is lower than an air pressure at said dehumidifying unit to enhance a diffusion of said exhaust air from said dehumidifying unit to said humidifying unit through said humidifying converter.

6. The air humidifying system, as recited in claim 4, wherein an air pressure at said humidifying unit is lower than an air pressure at said dehumidifying unit to enhance a diffusion of said exhaust air from said dehumidifying unit to said humidifying unit through said water permeable membrane.

7. The air humidifying system, as recited in claim 1, further comprising a first air valve communicatively connecting between said dry air inlet of said humidifying unit and said air filtering outlet of said air filtering unit and a second air valve communicatively connecting between said humidified air outlet of said humidifying unit and said air filtering outlet of said air filtering unit, wherein said first and second air valves automatically control said dry air flow entering into said humidifying unit for controlling a relative humidity of said humidified air supplied to said fuel cell stack.

8. The air humidifying system, as recited in claim 2, further comprising a first air valve communicatively connecting between said dry air inlet of said humidifying unit and said air filtering outlet of said air filtering unit and a second air valve communicatively connecting between said humidified air outlet of said humidifying unit and said air filtering outlet of said air filtering unit, wherein said first and second air valves automatically control said dry air flow entering into said humidifying unit for controlling a relative humidity of said humidified air supplied to said fuel cell stack.

9. The air humidifying system, as recited in claim 5, further comprising a first air valve communicatively connecting between said dry air inlet of said humidifying unit and said air filtering outlet of said air filtering unit and a second air valve communicatively connecting between said humidified air outlet of said humidifying unit and said air filtering outlet of said air filtering unit, wherein said first and second air valves automatically control said dry air flow entering into said humidifying unit for controlling a relative humidity of said humidified air supplied to said fuel cell stack.

10. The air humidifying system, as recited in claim 6, further comprising a first air valve communicatively connecting between said dry air inlet of said humidifying unit and said air filtering outlet of said air filtering unit and a second air valve communicatively connecting between said humidified air outlet of said humidifying unit and said air filtering outlet of said air filtering unit, wherein said first and second air valves automatically control said dry air flow entering into said humidifying unit for s controlling a relative humidity of said humidified air supplied to said fuel cell stack.

11. The air humidifying system, as recited in claim 1, wherein said air supplying unit comprises a high pressurizing fan operatively connecting between said humidified air outlet of said humidifying unit and said air inlet of said fuel cell stack for pressurizing said humidified air into said fuel cell stack.

12. The air humidifying system, as recited in claim 2, wherein said air supplying unit comprises a high pressurizing fan operatively connecting between said humidified air outlet of said humidifying unit and said air inlet of said fuel cell stack for pressurizing said humidified air into said fuel cell stack.

13. The air humidifying system, as recited in claim 9, wherein said air supplying unit comprises a high pressurizing fan operatively connecting between said humidified air outlet of said humidifying unit and said air inlet of said fuel cell stack for pressurizing said humidified air into said fuel cell stack.

14. The air humidifying system, as recited in claim 10, wherein said air supplying unit comprises a high pressurizing fan operatively connecting between said humidified air outlet of said humidifying unit and said air inlet of said fuel cell stack for pressurizing said humidified air into said fuel cell stack.

15. The air humidifying system, as recited in claim 1, wherein said air supplying unit comprises an air compressor operatively connecting between said humidified air outlet of said humidifying unit and said air inlet of said fuel cell stack for pressurizing said humidified air into said fuel cell stack.

16. The air humidifying system, as recited in claim 2, wherein said air supplying unit comprises an air compressor operatively connecting between said humidified air outlet of said humidifying unit and said air inlet of said fuel cell stack for pressurizing said humidified air into said fuel cell stack.

17. The air humidifying system, as recited in claim 13, wherein said air supplying unit comprises an air compressor operatively connecting between said humidified air outlet of said humidifying unit and said air inlet of said fuel cell stack for pressurizing said humidified air into said fuel cell stack.

18. The air humidifying system, as recited in claim 14, wherein said air supplying unit comprises an air compressor operatively connecting between said humidified air outlet of said humidifying unit and said air inlet of said fuel cell stack for pressurizing said humidified air into said fuel cell stack.
